(19) United States
(12) Patent Application Publication
(10) Pub. No.: US 2015/0300940 A1
(43) Pub. Date: Oct. 22, 2015

(54) FLUIDIC SYSTEM AND METHOD

(71) Applicant: CYTOFLOW, LLC, Durham, NC (US)

(72) Inventor: Nathaniel C. Bair, San Luis Obispo, CA (US)

(21) Appl. No.: 14/647,870

(22) PCT Filed: Nov. 27, 2013
(86) PCT No.: PCT/US2013/072225

§ 371 Date: May 28, 2015

Related U.S. Application Data
(60) Provisional application No. 61/814,959, filed on Apr. 23, 2013.
(60) Provisional application No. 61/731,190, filed on Nov. 29, 2012.

(51) Int. Cl. G01N 15/14

(52) U.S. Cl. CPC G01N 15/1404

(57) ABSTRACT

A fluidic system (10) and method are provided for precisely controlling fluid flow through a flow cytometer (12), with infinitely variable flow rates and sample fluid core sizes, by independently controlling fluid flow rates via fluid pump speeds. In one embodiment, the system uses two cyclic positive-displacement pumps (36, 38) and three valves (40, 42, 44), and operates via the precise control of the pumps (36, 38) along with coordinated operation of the valves (40, 42, 44). In another embodiment, the system uses constant-flow positive-displacement pumps, without need for valves associated with cyclic pumps. The fluid flow rates and core sizes may be determined or selected by correlating pump operating parameters to fluid flow rate.

### FIELD OF THE INVENTION

The present invention relates generally to fluid-handling or fluidic systems in which it is desirable to precisely control two or more different fluids flowing simultaneously within a single fluid conduit, such as for fluid analysis or testing purposes.

### BACKGROUND OF THE INVENTION

Fluid-handling or fluidic systems in which two or more different and substantially unmixed fluids flow together through a conduit, such as for analysis or testing purposes, may require precise control of the flow rates of the fluids. For example, a flow cytometer is a device used for optical detection of microscopic particles contained within a sample fluid that forms a “core”, which is surrounded by a conducting or “sheath” fluid, in which the two fluids flow simultaneously through a test chamber of a flowcell. The ability to detect certain particles within the sample fluid may be altered by changing the flow rate and/or the core diameter of the sample fluid within the conducting fluid. Using hydrodynamic focusing, a sample fluid is injected or drawn, via a sample injection probe, to within the center of a stream of conducting fluid (i.e., a “sheath fluid”). When the combined fluids leave the flowcell, it is known as “waste”. The cross section diameter of the sample fluid within the sheath fluid is known as the “core size”. The rate at which the sample fluid is drawn is known as the “flow rate”. Known flow cytometers are described, for example, in U.S. Pat. Nos. 8,303,894; 8,283,177; 8,262,990; and 8,187,888, the disclosures of which are hereby incorporated herein by reference for purposes of general background information on known flow cytometer structures.

Traditional cytometry systems use air pressure within a sample fluid vial to control the sample fluid flow rate through the sample injection probe. This forces the operator to use only a specific vial with the specific geometry to accommodate sealing and pressure mechanisms of the cytometer. Typical cytometers only provide for a limited number of core sizes and flow rates for the operator to select. Typical air-over-water cytometry systems may have five or more valves to control basic operations, and typically use pressure sensors for control feedback.

### SUMMARY OF THE INVENTION

The present invention provides a method and apparatus for controlling fluid within a flow cytometer system, which provides for a substantially infinite combination of flow rates and sample core sizes with only two positive displacement fluid pumps or pump modules. The present invention works by precise flow rate control of the fluid pumps, such as through the use of rotational position encoders on syringe pumps, or using gear pumps or another type of pump (typically a positive displacement pump) for which fluid flow rate is precisely controllable, and preferably without the use of a control feedback loop (i.e. based on separate pressure or flow rate sensors or flow rate sensors) that is separate from the pump modules themselves. It is envisioned that such precise flow rate control may obviate the need for traditional pressure sensors for control feedback, although it is envisioned that pressure sensors may still be used in certain embodiments. This increases reliability and robustness of the system by eliminating pressure sensors as potential failure modes or failure points. The system of the present invention is also operable with just three valves, although it is envisioned that a lesser or greater number of valves may be used to achieve different levels of functionality. The system evokes or induces sample fluid flow by pump speed differential alone, and thus is able to accommodate a wide variety of sample vials.

According to one form of the present invention, a fluidic system is provided for moving at least two fluids through a test chamber. The fluidic system includes a flowcell having the test chamber, and first and second fluid pumps. The test chamber is configured to receive a first fluid from a first fluid source, and a second fluid from a second fluid source. The first fluid pump is operable to direct the first fluid from the first fluid source to the test chamber of the flowcell, and the second fluid pump configured to draw both the first fluid and the second fluid through the test chamber. In the test chamber, the second fluid forms a fluid core that is substantially surrounded by a fluid sheath that is formed by the first fluid, which facilitates analysis of the second fluid as it moves through the test chamber. The first fluid pump is operable in a manner that allows a core diameter of the second fluid to be decreased while a flow rate of the second fluid remains substantially fixed, by operating the first fluid pump at an increased flow rate, which increases a first fluid flow rate out of the first fluid pump and into the test chamber. The first fluid pump is also operable to increase the core diameter of the second fluid while the flow rate of the second fluid remains substantially fixed, by operating the first fluid pump at a decreased flow rate to thereby decrease the first fluid flow rate out of the first fluid pump and into the test chamber.

According to another form of the present invention, a fluidic system is provided for moving fluid through a test chamber of a flow cell. The fluidic system includes a conducting fluid pump and a waste fluid pump, in addition to the flow cell with test chamber. The test chamber is configured to receive a conducting fluid from a conducting fluid source, and a sample fluid from a sample fluid source. The conducting fluid pump is configured to direct the conducting fluid from the conducting fluid source to the test chamber of the flowcell. The waste fluid pump is configured to draw the conducting fluid and the sample fluid through the test chamber, in a manner so that the sample fluid forms a fluid core that is substantially surrounded by a fluid sheath formed by the conducting fluid in the test chamber. This facilitates the optical detection of particles contained within the sample fluid in the test chamber. The conducting fluid pump is operable to decrease a core diameter of the sample fluid while a flow rate of the sample fluid remains substantially fixed. This is accomplished by operating the conducting fluid pump at an increased flow rate, to thereby increase a conducting fluid flow rate out of the conducting fluid pump and into the test chamber. The conducting fluid pump is further operable to increase the core diameter of the sample fluid while the flow rate of the sample fluid remains substantially fixed, by operating the conducting fluid pump at a decreased flow rate to thereby decrease the conducting fluid flow rate out of the conducting fluid pump and into the test chamber.

In one aspect, the conducting fluid pump is further operable to adjust the flow rate of the sample fluid while the core diameter of the sample fluid remains substantially fixed, by adjusting a conducting fluid flow rate out of the conducting fluid pump and into the test chamber by a conducting fluid flow rate scaling factor, which is substantially the same as a sample fluid flow rate scaling factor by which the sample fluid flow rate is adjusted out of the sample fluid source and into the test chamber via operation of the waste fluid pump.

In another aspect, the conducting fluid pump and the waste fluid pump each includes a syringe pump. Optionally, each of the conducting fluid pump and the waste fluid pump includes a rotational position encoder configured to enable precise control of the fluid pumps.

Optionally, the fluidic system further includes an electronic control system in communication with the conducting fluid pump and the waste fluid pump, such as with rotational position encoders associated therewith.

In yet another aspect, the fluidic system further includes a supply control valve that is in selective fluid communication with the conducting fluid pump and the flowcell, and a waste control valve that is in selective fluid communication with the flowcell and the waste fluid pump. Optionally, the supply control valve and the waste control valve are controllable via electronic communication with the electronic control system. The supply control valve may include a three-way valve that is further in selective fluid communication with the conducting fluid source, so that the supply control valve is operable to control the flow of the conducting fluid from the conducting fluid source to the conducting fluid pump, and from the conducting fluid pump to the test chamber of the flowcell. Optionally, the waste control valve is a three-way valve that is in selective fluid communication with a waste tank or a drain, so that the waste control valve is operable to control the flow of the conducting fluid and the sample fluid from the test chamber of the flowcell to the waste fluid pump, and from the waste fluid pump to a waste tank or a drain.

In still another aspect, the fluidic system includes a waste-or-purge selector valve that is in selective fluid communication with the flowcell via a fluidic waste line and a fluidic purge line, and the waste-or-purge selector valve is operable to cause momentary fluid pressure pulses in the test chamber of the flowcell.

In a still further aspect, the fluidic system further includes a sample injection probe in fluid communication with the sample fluid source and with the test chamber of the flowcell.

In another aspect, the fluidic system is provided in combination with a flow cytometer.

According to another form of the present invention, a method is provided for controlling the flow of fluids through a flow cytometer. The method includes (i) pumping a conducting fluid from a conducting fluid source to a test chamber of a flow cell with a conducting fluid pump; (ii) measuring, at the conducting fluid pump, a flow rate of the conducting fluid into the test chamber; (iii) simultaneously drawing the conducting fluid and a sample fluid through the test chamber with a waste fluid pump, whereby the conducting fluid forms a fluid sheath surrounding a fluid core of the sample fluid; (iv) measuring, at the waste fluid pump, a combined flow rate of the conducting fluid and the sample fluid through the test chamber, (v) calculating a sample fluid flow rate by subtracting the flow rate of the conducting fluid from the flow rate of the waste fluid; (vi) optically detecting particles contained within the sample fluid in the test chamber; and at least one of: (a) operating the conducting fluid pump at an increased flow rate to decrease a core diameter of the sample fluid while a flow rate of the sample fluid remains substantially fixed; (b) operating the conducting fluid pump at a decreased flow rate to increase the core diameter of the sample fluid while the flow rate of the sample fluid remains substantially fixed; and (c) increasing or decreasing the flow rate of the sample fluid while the core diameter of the sample fluid remains substantially fixed, by operating the conducting fluid pump at an increased or decreased conducting fluid flow rate relative to a standard conducting fluid flow rate according to a first scaling factor, while simultaneously operating the waste fluid pump to generate an increased or decreased sample fluid flow rate relative to a standard sample fluid flow rate according to a second scaling factor, where the first and second scaling factors are substantially the same.

Thus, the fluidic system and method of the present invention allows a flow cytometer to be constructed with fewer components and, thus, with greater reliably and at lower cost, while also allowing an operator to use substantially any desired sample vial, and to select substantially any desired fluid flow rates and sample core sizes.

These and other objects, advantages, purposes and features of the present invention will become apparent upon review of the following specification in conjunction with the drawings.

### BRIEF DESCRIPTION OF THE DRAWINGS

FIG. 1 is a diagrammatic view of a fluidic system in accordance with the present invention;

FIG. 2 is a side elevation diagram of a sample fluid in a conducting fluid;

FIG. 3 is a sectional diagram of the sample and conducting fluids taken along section line III-III in FIG. 2; and

FIG. 4 is a block diagram of a flow cytometer incorporating a fluidic system in accordance with the present invention.

### DESCRIPTION OF THE PREFERRED EMBODIMENTS

The fluidic system of the present invention provides an apparatus and method for allowing a core size and flow rate of a sample fluid in a flow cytometer to be substantially infinitely adjustable between respective minimum and maximum values. The core size and flow rate may be adjusted according to properties of the sample fluid or the nature of the experiment, for example. It is envisioned that the fluidic system would be compatible or adaptable for use with many different known flow cytometers, such as those described in U.S. Pat. Nos. 8,303,894; 8,283,177; 8,262,990; and 8,187,888, although it will be appreciated that the fluidic system of the present invention may be used in conjunction with other flow cytometer structures, as well as other fluid or fluidic systems not related to cytometry, and is in no way limited to those of the above-referenced patents.

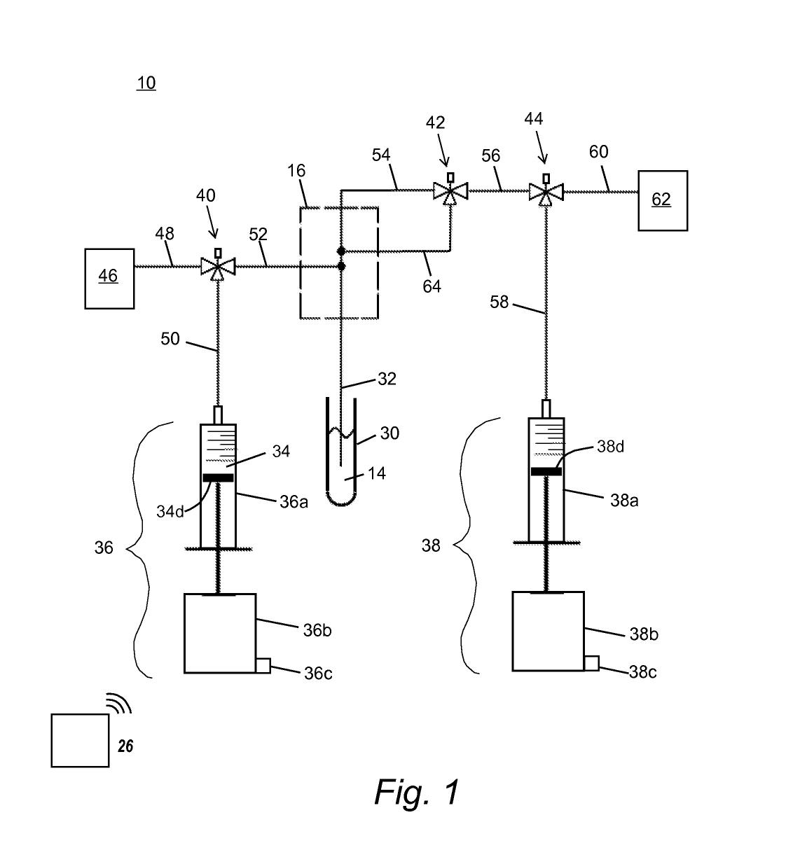

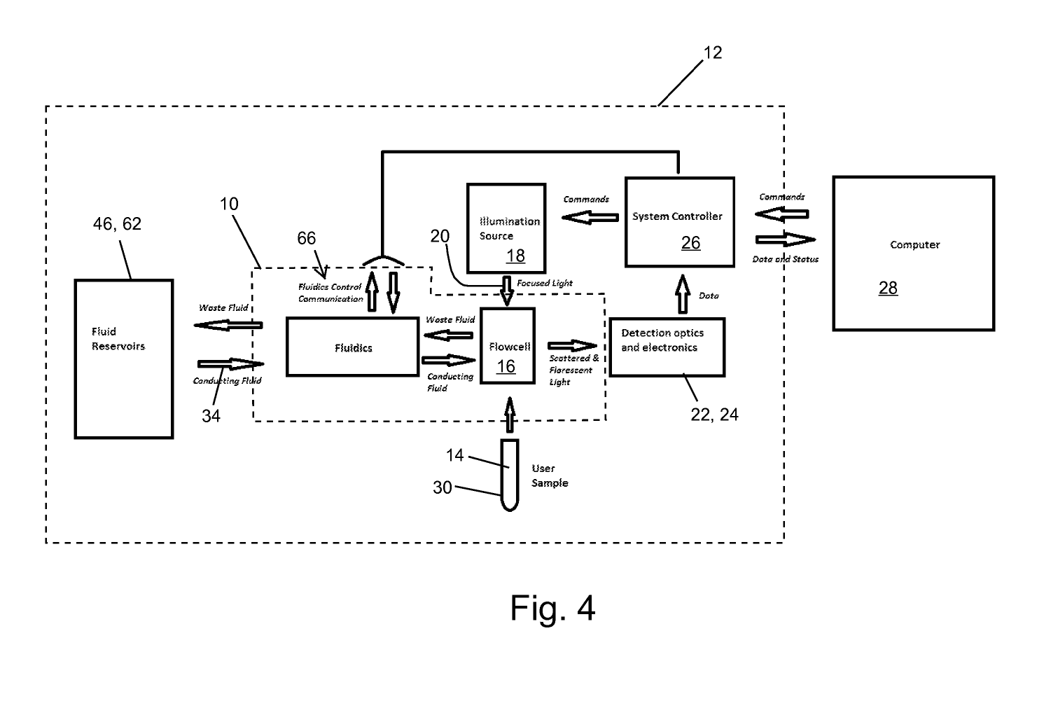

Referring now to the drawings and the illustrative embodiments depicted therein, a fluidic system 10 (FIGS. 1 and 4) moves fluids through a flow cytometer 12 (FIG. 4) in a precisely controlled manner, for the optical detection of microscopic particles contained within a sample fluid 14 that moves through a flowcell 16 of fluidic system 10. In addition to fluidic system 10, flow cytometer 12 will typically include an illumination source 18 that directs focused light 20 at flowcell 16, and further includes detection optics 22 and associated electronics 24. Flow cytometer 12 also includes an electronic control system 26 that is operable to control fluidic system 10, illumination source 18, and detection optics 22 and electronics 24, in response to commands received by a separate computer 28 (such as a lab workstation) that is run by an operator, such as shown in FIG. 4.

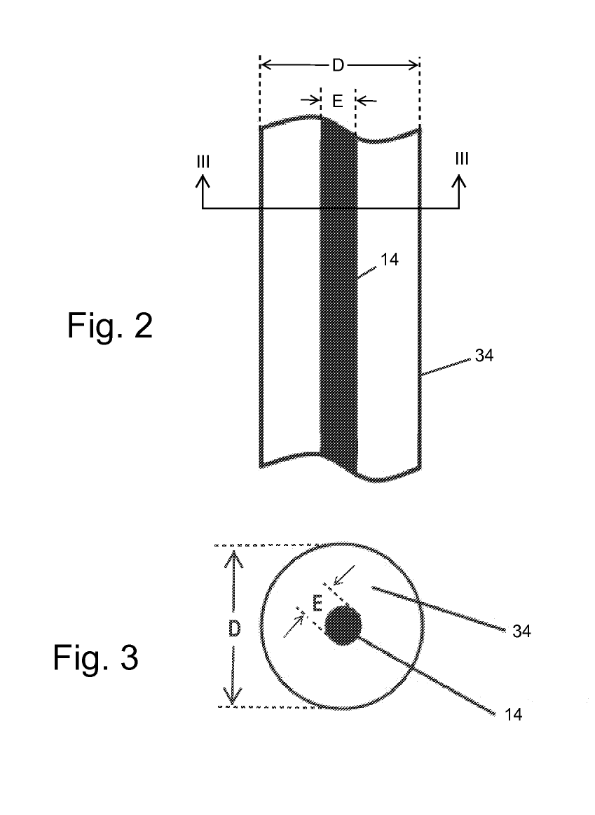

In fluidic system 10, the sample fluid 14 originates from a fluid source or reservoir 30 (FIGS. 1 and 4), such as a sample vial that is typically located outside of flowcell 16. The sample fluid 14 is injected or drawn, via a sample injection probe 32, to within the center of a stream of conducting or “sheath” fluid 34 (FIGS. 2 and 3). The cross section diameter of the sample fluid 14 within the sheath fluid 34 is referred to as the “core size” (refer to dimension E in FIG. 3), and the rate at which the sample fluid 14 is drawn through sample injection probe 32 is referred to as the “flow rate”. When the combined fluids leave the flowcell 16, the combined fluids 14, 34 are considered waste.

The fluidic system 10 includes two electronic controllable positive displacement pumps, including a supply pump module 36 and a waste pump module 38 (FIG. 1). In the illustrated embodiment of FIG. 1, supply pump module 36 and waste pump module 38 are each syringe pumps having respective syringe portions 36a, 38a and powered drive portions 36b, 38b. Powered drive portions 36b, 38b may include respective rotational position encoders 36c, 38c that detect and transmit the rotational position of a pump component (e.g., a threaded rotatable drive shaft on which a threaded linear-displacement nut is mounted, which drives a plunger 36d, 38d of the respective syringe portion 36a or 38a) to allow for precise flow rate control of the fluid pump modules 36, 38. Optionally, it is envisioned that fluidic system 10 may be equipped with a supply pump and/or a waste pump in the form of precisely-controllable gear pump or other “rotary” pumps, or substantially any other fluid pump capable of operating independently at precisely controlled flow rates, either with or without the use of separate system pressure sensors or the like.

In addition, fluidic system 10 includes three electronic controllable 3-way valves, including a supply control valve 40, a waste-or-purge selector valve 42, and a waste control valve 44. Fluidic system 10 further includes the flowcell 16 and the sample injection probe 32, as well as a plurality of fluidic lines (48, 50, 52, 54, 56, 58, 60, 62, 64) that are described below. Fluidic system 10 is operated by electronic control system 26 (FIG. 4), which operates or controls the pumps and valves in a sequenced manner, and which may be in electronic communication with valves 40, 42, 44 and powered drive portions 36b, 38b of pumps 36, 38, or with fluidics control circuitry 66 that is associated therewith.

Fluidic system 10 operates by first drawing the conducting fluid 34 from a supply tank 46 and into syringe portion 36a of supply syringe pump module 36 via a first fluidic supply line 48 that feeds into a supply control valve 40 (FIG. 1). Conducting fluid 34 enters syringe portion 36a of supply syringe pump module 36 via a second fluidic line 50, which connects the syringe portion 36a of supply syringe pump module 36 to the supply control valve 40. Then, the supply syringe pump 36 pushes the conducting fluid 34 into the flowcell 16, via the supply control valve 40 (which has been actuated to route the conducting fluid 34 accordingly) and a third fluid line 52 that leads from supply control valve 40 to flowcell 16. Simultaneously with this action by supply syringe pump module 36, waste syringe pump module 38 draws fluid (either conducting fluid 34 alone, or conducting fluid 34 combined with sample fluid 14) from the flowcell 16 via a fluidic waste line 54, which connects flowcell 16 to a waste-or-purge selector valve 42, and also via a selector-to-waste-valve connection line 56, a waste control valve 44, and a fluidic line 58 that connects the selector-to-waste-valve connection line 56 to waste syringe pump 38. When the waste syringe pump 38 is full, both of the pumps 36, 38 may pause momentarily, and then the waste syringe pump 38 reverses direction to push the waste fluid through the fluidic line 58 and the waste control valve 44, which has been actuated to direct the waste fluids through a fluidic waste line 60 and into a waste tank or drain 62.

However, as briefly noted above, it will be appreciated that a fluidic system may incorporate other forms or types of pumps or pump modules having precisely controllable fluid flow rates, without departing from the spirit and scope of the present invention. For example, a gear pump is substantially continuously operable to produce a continuous flow of fluid that is drawn in through an inlet and discharged through a separate outlet, and at a flow rate that is substantially continuously or infinitely variable. It is envisioned that such continuous-flow pumps, used in place of cyclically-operating syringe pumps, would substantially eliminate the need for valves that ensure that fluids flow in the desired conduits and in the desired directions during the cyclic operation of syringe pumps, such as is described above in connection with the illustrated embodiment.

Regardless of the types of pumps used in the fluidic system, any difference in flow rates of the two pumps 36, 38 will result in an induced flow of the sample fluid 14, either into or out of the flowcell 16 via the sample injection probe 32. In normal operation, the waste syringe pump 38 is running at a higher flow rate than the supply syringe pump 36, so that sample fluid 14 will be drawn into the flowcell 16 via the sample injection probe 32, and the sample fluid flow rate will equal the difference between the flow rate of the conducting fluid 34 out of supply syringe pump 36 (and into flowcell 16) and the flow rate of the combined fluids 14, 34 flowing out of the flowcell 16. Thus, the amount of sample fluid 14 being transferred into the flowcell 16 via the sample injection probe 32 can be represented by the equation:

A−B=C

Where ‘A’ is the flow rate of the waste syringe pump 38, ‘B’ is the flow rate of the supply syringe pump 36, and ‘C’ is the resulting flow rate of the sample fluid 14 through the sample injection probe 32. When C is negative, the sample fluid 14 is flowing away from flowcell 16 and into the reservoir 30 of sample fluid 14, such as during a cleaning or purging operation. However, for normal test operation C is positive, so that the flow direction of the sample fluid 14 is out of the reservoir 30 and into the flowcell 16.

The sample fluid's core size is the diameter ‘E’ of the stream of sample fluid 14 that is sheathed within the stream of conducting fluid 34, such as shown in FIGS. 2 and 3. The core size E generally relates to the ratio of the flow rate B of the conducting fluid 34 to the flow rate C of the sample fluid 14, and the internal diameter ‘D’ of a fluid test channel (which may be a quartz fluid channel or capillary, for example) in the flowcell 16 according to the following simplified formula:

E=D*C/B

It will be appreciated that the above relationship is over-simplified for purposes of obtaining a general understanding of the manner in which core size of the sample fluid relates to the diameter of the sample fluid core and the inner and outer diameters of the sheath (conducting) fluid. For example, the above relationship does not take into account the effect of different fluid viscosities and/or specific gravities of the sample and conducting fluids, fluid friction, etc., which can be factored in to calculations as appropriate.

The electronic control system 26 allows for the independent adjustment of either the core size E or the flow rate C of the sample fluid 14, while keeping the other of the flow rate C or the core size E substantially fixed. To adjust the flow rate C of the sample fluid 14 while maintaining the core size E, the respective flow rates B, C of the two pumps 36, 38 can be scaled up or down with the flow rate C of the sample fluid 14 by substantially the same scaling factor X. Thus, the following equation or relationship is representative:

A*X−B*X=C*X

Then it follows that the core size E will be substantially preserved:

E=D*(C*X)/(B*X); and

E=D*C/B

Accordingly, if the supply fluid pump 36 is operated at a substantially constant standard conducting fluid flow rate B while the waste fluid pump 38 is operated at a substantially constant standard waste (combined) fluid flow rate A to generate a standard sample fluid flow rate C, then the core size E will be at a substantially constant and readily determinable dimension. If the supply fluid pump 36 is then operated at a new conducting fluid flow rate that is 25% greater than B (i.e., 1.25*B) and the waste fluid pump 38 is operated at a new fluid flow rate that generates a new sample fluid flow rate which is 25% greater than C (i.e., 1.25*C), then the new conducting fluid flow rate of 1.25*B has been scaled up by approximately the same ratio as the new sample fluid flow rate of 1.25*C, and the core size E will be substantially the same as when the supply fluid pump 36 and waste fluid pump 38 were producing the standard conducting fluid flow rate B and the standard supply fluid flow rate C. It will be readily understood that reducing the flow rates of the supply fluid pump 36 and waste fluid pump 38 to reduce the conducting fluid flow rate B and the standard supply fluid flow rate C (e.g., to 0.75*B and 0.75*C), the core size E would remain unchanged. Thus, changing the conducting fluid flow rate and the supply fluid flow rate by the same scaling factor or ratio will result in substantially the same core size in the flowcell 16, but at an increased or reduced fluid flow rate.

It is envisioned that the sample injection probe 32 could potentially become clogged with particles that are contained within the sample fluid 14, resulting in unfavorable performance of the fluidic system 10 or no performance at all. In this event, the fluidic system 10 allows for clearing of such a clog by forcing conducting fluid 34 down the sample injection probe 32 (i.e., in the direction of reservoir 30). To accomplish this, the waste syringe pump 38 is disengaged (e.g., by closing third fluid line 52 at supply control valve 40), the waste control valve 44 is closed to the selector-to-waste-valve connection line 56, and the sample vial or reservoir 30 is removed (or at least does not contain a sample fluid that could be contaminated), and the supply syringe pump 36 is operated to push conducting fluid 34 through the supply control valve 40 and into the flowcell 16, thereby resulting in conducting fluid 34 being pushed (“back-flushed”) down the sample injection probe 32. The back-flushed conducting fluid 34 may be collected in an empty reservoir 30 or another receptacle positioned at probe 32 for that purpose. Once the back-flushing is complete, a reservoir 30 containing a sample fluid 14 may be replaced at sample injection probe 32 to resume normal operation of the flow cytometer 12.

It is further envisioned that the stream of sample fluid 14 may occasionally be disrupted by debris or air bubbles (“disturbances”) entrapped in the hydrodynamic focusing area of the flowcell 16. Typical flowcells have a purge port in this area to provide a path for clearing the disturbance. However, typical fluidic systems have difficulty clearing such disturbances, may contaminate the sample fluid by accidentally back-flushing, and may require an extended time to recover before being capable of resuming normal operation.

However, the fluidic system 10 allows for clearing such disturbances from a hydrodynamic focusing zone, and/or from the test chamber of the flowcell 16, in the following manner and without such undesirable effects: 1) both pumps 36, 38 are operated at the same flow rate to ensure no fluid is flowing through the sample injection probe 32, which could contaminate the sample fluid 14; 2) the flow rate can be increased to an extent necessary to dislodge the disturbance using higher velocities of the supply fluid 34; 3) the waste-or-purge selector valve 42 can be rapidly oscillated to invoke momentary pressure pulses through a fluidic purge line 64 that is in fluid communication with the test chamber of the flowcell 16 and with the waste-or-purge selector valve 42, which may help to dislodge the disturbances; and 4) the system can rapidly return to normal operation by simply reducing the flow rates.

Thus, the present invention provides a method and apparatus for precisely controlling fluid within a flow cytometer system, which provides for an infinite combination of flow rates and sample fluid core sizes by precisely controlling pump speeds. The system uses two positive displacement pumps and three valves, and operates via the precise control of the positive displacement pumps, typically through rotational position encoders that negate the need for traditional pressure sensors for control feedback. The resulting system exhibits increased reliability and robustness compared to systems utilizing additional pumps, valves, and sensors in different arrangements.

Changes and modifications to the specifically described embodiments may be carried out without departing from the principles of the present invention, which is intended to be limited only by the scope of the appended claims, as interpreted according to the principles of patent law, including the doctrine of equivalents.

1. A method of controlling the flow of fluids through a flow cytometer, said method comprising:
pumping a conducting fluid from a conducting fluid source to a test chamber of a flow cell with a conducting fluid pump;
measuring, at the conducting fluid pump, a flow rate of the conducting fluid into the test chamber;
simultaneously with said pumping the conducting fluid from the conducting fluid source to the test chamber, drawing the conducting fluid and a sample fluid through the test chamber with a waste fluid pump, whereby the conducting fluid forms a fluid sheath surrounding a fluid core of the sample fluid;
measuring, at the waste fluid pump, a combined flow rate of the conducting fluid and the sample fluid through the test chamber;
calculating a sample fluid flow rate by subtracting the flow rate of the conducting fluid from the combined flow rate of the waste fluid;
optically detecting particles contained within the sample fluid in the test chamber; and
at least one chosen from:
(i) operating the conducting fluid pump at an increased or decreased flow rate to decrease or increase a core diameter of the sample fluid; and
(ii) operating the conducting fluid pump and the waste fluid pump to change the flow rate of the sample fluid while the core diameter of the sample fluid remains fixed, by operating the conducting fluid pump at a changed conducting fluid flow rate that differs from a standard conducting fluid flow rate by a first scaling factor multiplier, while simultaneously operating the waste fluid pump to generate a changed sample fluid flow rate that differs from a standard sample fluid flow rate by a second scaling factor multiplier that is substantially the same as the first scaling factor multiplier.

2. The method according to claim 1, wherein said measuring at the waste fluid pump and said measuring at the conducting fluid pump are performed using rotational position encoders.

3. The method according to claim 1, wherein said pumping the conducting fluid from the conducting fluid source to the test chamber of the flowcell comprises:
actuating a supply control valve so that the conducting fluid pump is in fluid communication with the conducting fluid source;
operating the conducting fluid pump to draw the conducting fluid from the conducting fluid source and into or toward the conducting fluid pump via the supply control valve;
actuating the supply control valve so that the conducting fluid pump is in fluid communication with the test chamber of the flowcell, and so that the conducting fluid pump is not in fluid communication with the conducting fluid source; and
operating the conducting fluid pump to urge the conducting fluid from the conducting fluid pump to the flowcell via the supply control valve.

4. The method according to claim 1, wherein said drawing the conducting fluid and the sample fluid through the test chamber comprises:
actuating a waste control valve so that the waste fluid pump is in fluid communication with the test chamber of the flowcell and with a sample fluid source;
operating the waste fluid pump to draw the conducting fluid and the sample fluid through the test chamber of the flow cell via the waste control valve;
actuating the waste control valve so that the waste fluid pump is in fluid communication with a waste tank or a drain, and so that the waste fluid pump is not in fluid communication with the test chamber of the flow cell; and
operating the waste fluid pump to urge the conducting fluid and the sample fluid away from the waste fluid pump and into to the waste tank or drain via the waste control valve.

5. A fluidic system for moving at least two fluids through a test chamber, said fluidic system comprising:
a flowcell including a test chamber, said flowcell configured to receive in said test chamber (i) a first fluid from a first fluid source, and (ii) a second fluid from a second fluid source;
a first fluid pump configured to direct the first fluid from the first fluid source to said test chamber of said flowcell;
a second fluid pump configured to draw the first fluid and the second fluid through said test chamber, whereby the second fluid forms a fluid core that is substantially surrounded by a fluid sheath formed by the first fluid in said test chamber, to facilitate analysis of the second fluid in said test chamber;
wherein said first and second fluid pumps are operable together to change a core diameter of the second fluid while a flow rate of the second fluid remains substantially fixed, by operating said first fluid pump at a changed first fluid flow rate and by operating said second fluid pump at a changed combined fluid flow rate so that the change in the combined fluid flow rate is volumetrically substantially the same as the change in the first fluid flow rate, to thereby change only the first fluid flow rate through said test chamber; and
wherein said first fluid and second fluid pumps are further operable to change the flow rate of the second fluid while maintaining the same core diameter of the second fluid, by operating said first fluid pump at a first fluid flow rate that is changed by a first scaling factor, and by simultaneously operating said second fluid pump at a combined fluid flow rate that results in a second fluid flow rate that is changed by a second scaling factor that substantially equals the first scaling factor.

6. The fluidic system of claim 5, wherein said first and second fluid pumps comprise positive-displacement pumps.

7. The fluidic system of claim 6, further in combination with a flow cytometer comprising a light source directed at said test chamber of said flowcell, and further comprising an optical detector operable to receive and analyze light passing through said test chamber.

8. A fluidic system for moving at least two fluids through a test chamber, said fluidic system comprising:
a flowcell including a test chamber, said flowcell configured to receive in said test chamber: (i) a conducting fluid from a conducting fluid source, and (ii) a sample fluid from a sample fluid source;
a conducting fluid pump operable to direct the conducting fluid from the conducting fluid source to said test chamber of said flowcell;
a waste fluid pump operable to draw the conducting fluid and the sample fluid together through said test chamber, whereby the sample fluid forms a fluid core that is substantially surrounded by a fluid sheath formed by the conducting fluid in said test chamber, to facilitate optical detection of particles contained within the sample fluid in said test chamber;
wherein said conducting fluid pump and said waste fluid pump are operable to decrease a core diameter of the sample fluid while a flow rate of the sample fluid remains substantially fixed, by operating said conducting fluid pump at an increased conducting fluid flow rate to thereby increase a conducting fluid flow rate out of said conducting fluid pump and into said test chamber, and by operating said waste fluid pump at an increased combined fluid flow rate so that the increase in the combined fluid flow rate is volumetrically substantially the same as the increase in the conducting fluid flow rate; and
wherein said conducting fluid pump and said waste fluid pump are further operable to increase the core diameter of the sample fluid while the flow rate of the sample fluid remains substantially fixed, by operating said conducting fluid pump at a decreased conducting fluid flow rate to thereby decrease the conducting fluid flow rate out of said conducting fluid pump and into said test chamber, and by operating said waste fluid pump at a decreased combined fluid flow rate so that the decrease in the combined fluid flow rate is volumetrically substantially the same as the decrease in the conducting fluid flow rate.

9. The fluidic system of claim 8, wherein said conducting fluid pump and said waste fluid pump are operable to adjust the flow rate of the sample fluid while the core diameter of the sample fluid remains substantially fixed, by adjusting the conducting fluid flow rate out of said conducting fluid pump and into said test chamber by a conducting fluid flow rate scaling factor that is substantially the same as a sample fluid flow rate scaling factor by which the sample fluid flow rate is adjusted out of the sample fluid source and into said test chamber via operation of said waste fluid pump.

10. The fluidic system of claim 8, wherein said conducting fluid pump and said waste fluid pump each comprises a syringe pump.

11. The fluidic system of claim 8, wherein said conducting fluid pump and said waste fluid pump each comprises a rotational position encoder configured to enable precise control of said fluid pumps.

12. The fluidic system of claim 8, further comprising an electronic control system in communication with said conducting fluid pump and said waste fluid pump.

13. The fluidic system of claim 12, further comprising:
a supply control valve in selective fluid communication with said conducting fluid pump and said flowcell; and
a waste control valve in selective fluid communication with said flowcell and said waste fluid pump.

14. The fluidic system of claim 13, wherein said supply control valve and said waste control valve are controllable via electronic communication with said electronic control system.

15. The fluidic system of claim 13, wherein said supply control valve comprises a three-way valve that is further in selective fluid communication with the conducting fluid source, wherein said supply control valve is operable to control the flow of the conducting fluid from the conducting fluid source to said conducting fluid pump, and from said conducting fluid pump to said test chamber of said flowcell.

16. The fluidic system of claim 13, wherein said waste control valve comprises a three-way valve that is further in selective fluid communication with a waste tank or a drain, wherein said waste control valve is operable to control the flow of the conducting fluid and the sample fluid from said test chamber of said flowcell to said waste fluid pump, and from said waste fluid pump to the waste tank or the drain.

17. The fluidic system of claim 13, further comprising a waste-or-purge selector valve that is in selective fluid communication with said flowcell via a fluidic waste line and a fluidic purge line, wherein said waste-or-purge selector valve is operable to cause momentary fluid pressure pulses in said test chamber of said flowcell.

18. The fluidic system of claim 8, further comprising a sample injection probe in fluid communication with the sample fluid source and with said test chamber of said flowcell.

19. The fluidic system of claim 8, further in combination with a flow cytometer.

20. A fluidic system for moving fluids through a flow cytometer, said fluidic system comprising:
a conducting fluid source configured to contain a conducting fluid;
a flowcell configured to receive the conducting fluid and a sample fluid in a test chamber;
a conducting fluid pump configured to direct the conducting fluid from said conducting fluid source to said test chamber of said flowcell;
wherein said conducting fluid pump is operable at a standard conducting fluid flow rate, and said conducting fluid pump is further operable at an increased or decreased conducting fluid flow rate, whereby the conducting fluid flow rate is adjustable by a first scaling factor relative to the standard conducting fluid flow rate;
a sample fluid source configured to contain the sample fluid;
a sample injection probe in fluid communication with said sample fluid source and said test chamber of said flowcell;
a waste fluid pump configured to draw the conducting fluid and the sample fluid through said test chamber, wherein the sample fluid forms a fluid core that is substantially surrounded by a fluid sheath formed by the conducting fluid in said test chamber to facilitate optical detection of particles contained within the sample fluid;
wherein said waste fluid pump is operable at a standard waste fluid flow rate that is greater than the standard conducting fluid flow rate to thereby generate a standard sample fluid flow rate, and said waste fluid pump is further operable at increased or decreased flow rates to generate an increased or decreased sample fluid flow rate, whereby the sample fluid flow rate is adjustable by a second scaling factor relative to the standard sample fluid flow rate;
wherein said conducting fluid pump and said waste fluid pump are operable to decrease or increase a core diameter of the sample fluid while maintaining a constant flow rate of the sample fluid, by operating said conducting fluid pump at an increased or decreased conducting fluid flow rate and by simultaneously operating said waste fluid pump at an increased or decreased combined fluid flow rate so that the increase in the combined fluid flow rate is volumetrically the same as the increase in the conducting fluid flow rate, to thereby increase or decrease the conducting fluid flow rate out of said conducting fluid pump and into said test chamber; and
wherein said conducting fluid pump and said waste fluid pump are operable to adjust the flow rate of the sample fluid while the core diameter of the sample fluid remains fixed, by setting the conducting fluid flow rate out of said conducting fluid pump and into said test chamber at the first scaling factor and by simultaneously operating said waste fluid pump to generate the sample fluid flow rate through said test chamber at the second scaling factor which is substantially equal to the first scaling factor.
